(19) United States
(12) Patent Application Publication
(10) Pub. No.: US 2022/0347925 A1
(43) Pub. Date: Nov. 3, 2022

(54) OFFSET OPERATORS

(71) Applicant: Hewlett-Packard Development Company, L.P., Spring, TX (US)

(72) Inventors: Sergio Gonzalez Martin, Sant Cugat del Valles (ES); Alex Carruesco Llorens, Sant Cugat del Valles (ES); Jordi Gonzalez Rogel, Sant Cugat del Valles (ES); Jordi Sanroma Garrit, Sant Cugat del Valles (ES); Victor Diego Gutierrez, Sant Cugat del Valles (ES); Enrique Gurdiel Gonzalez, Sant Cugat del Valles (ES); Victor Anton Dominguez, Sant Cugat del Valles (ES); Antonio Chica Calaf, Sant Cugat del Valles (ES); Alvaro Vinacua Pla, Sant Cugat del Valles (ES); Cristina Raluca Vijulie, Sant Cugat del Valles (ES)

(21) Appl. No.: 17/621,078

(22) PCT Filed: Jul. 15, 2019
(86) PCT No.: PCT/US2019/041810

§ 371 Date: Dec. 20, 2021

(51) Int. Cl. B29C 64/386; B33Y 50/00; B22F 10/80; G05B 19/4093

(52) U.S. Cl. CPC B29C 64/386; B33Y 50/00; B22F 10/80; G05B 19/40931; G05B 2219/49246

(57) ABSTRACT

In an example, a method includes receiving, at a processor, an object model describing a geometry of a three-dimensional object, and determining a transformed data model describing a volume containing a modified version of the three-dimensional object as a plurality of categorised contiguous, non-overlapping sub-volumes, wherein the modified version of the three-dimensional object includes a surface offset. Determining the transformed data model may comprises categorising the sub-volumes by defining a first region by determining an area swept by an offset operator when the offset operator is swept around a boundary of the sub-volume and defining a second region, interior to the first region, and indicative of the closest approach of the offset operator to the sub-volume when the offset operator is swept around the boundary. Intersections between a surface of the object model and at least one of the first and second region may be determined. When the surface intersects the second region, the sub-volume may be categorised as interior to the three-dimensional object; and when the surface intersects the first region and not the second region, the sub-volume may categorised as spanning a boundary of the three-dimensional object.

### BACKGROUND

Additive manufacturing techniques may generate a three-dimensional object on a layer-by-layer basis through the selective solidification of a build material. In examples of such techniques, build material is supplied in a layer-wise manner and a solidification method may include heating the layers of build material to cause melting in selected regions, for example in regions bearing a fusing agent. In other techniques, other solidification methods, such as chemical solidification methods or binding materials, may be used.

### BRIEF DESCRIPTION OF DRAWINGS

Non-limiting examples will now be described with reference to the accompanying drawings, in which:

FIG. 1 is a flowchart of an example method for generating data representing a three-dimensional object;

FIG. 2 is a flowchart of an example method for categorising sub-volumes;

FIG. 3 schematically shows the operation of an offset operator according to an example;

FIG. 4 is a flowchart of an example method for iteratively defining and categorising sub-volumes;

FIG. 5 schematically shows an example region which impact a set of sub-volumes;

FIG. 6 is a flowchart of an example method for applying a negative offset;

FIGS. 7 and 8 are schematic drawings of example apparatus for use in additive manufacturing; and

FIG. 9 is a schematic drawing of an example processor in conjunction with a machine readable medium.

### DETAILED DESCRIPTION

Additive manufacturing techniques may generate a three-dimensional object through the solidification of a build material. In some examples, the build material is a powder-like granular material, which may for example be a plastic, ceramic or metal powder and the properties of generated objects may depend on the type of build material and the type of solidification mechanism used. In some examples the powder may be formed from, or may include, short fibres that may, for example, have been cut into short lengths from long strands or threads of material. Build material may be deposited, for example on a print bed and processed layer by layer, for example within a fabrication chamber. According to one example, a suitable build material may be PA12 build material commercially referred to as V1R10A “HP PA12” available from HP Inc.

In some examples, selective solidification is achieved using heat in a thermal fusing additive manufacturing operation. This may comprise directional application of energy, for example using a laser or electron beam which results in solidification of build material where the directional energy is applied. In other examples, at least one print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be generated from structural design data). The fusing agent may have a composition which absorbs energy such that, when energy (for example, heat) is applied to the layer, the build material heats up, coalesces and solidifies upon cooling, to form a slice of the three-dimensional object in accordance with the pattern. In other examples, coalescence may be achieved in some other manner.

According to one example, a suitable fusing agent may be an ink-type formulation comprising carbon black, such as, for example, the fusing agent formulation commercially referred to as V1Q60A “HP fusing agent” available from HP Inc. In one example such a fusing agent may comprise any or any combination of an infra-red light absorber, a near infra-red light absorber, a visible light absorber and a UV light absorber.

In addition to a fusing agent, in some examples, a print agent may comprise a coalescence modifier agent, which acts to modify the effects of a fusing agent for example by reducing or increasing coalescence or to assist in producing a particular finish or appearance to an object, and such agents may therefore be termed detailing agents. In some examples, detailing agent may be used near edge surfaces of an object being printed to reduce or prevent coalescence by, for example, cooling the build material or through some other mechanism. According to one example, a suitable detailing agent may be a formulation commercially referred to as V1Q61A “HP detailing agent” available from HP Inc.

A coloring agent, for example comprising a dye or colorant, may in some examples be used as a fusing agent or a coalescence modifier agent, and/or as a print agent to provide a particular color for the object. Examples of print agents comprising dye based colored ink and pigment based colored ink include inks commercially referred to as CE039A and CE042A available from HP Inc.

As noted above, additive manufacturing systems may generate objects based on structural design data. This may involve a designer designing a three-dimensional model of an object to be generated, for example using a computer aided design (CAD) application. The model may define the solid portions of the object. To generate a three-dimensional object from the model using an additive manufacturing system, the model data may comprise, or can be processed to derive, slices or parallel planes of the model. Each slice may define a portion of a respective layer of build material that is to be solidified or caused to coalesce by the additive manufacturing system.

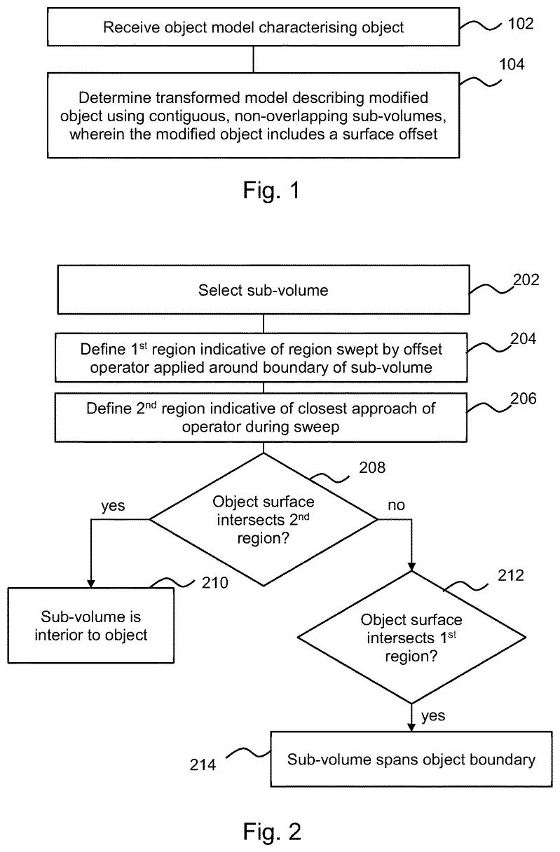

FIG. 1 is an example of a method, which may comprise a computer implemented method of determining a transformed data model of an object.

Block 102 comprises receiving, at a processor, a data model of a three-dimensional object comprising an object model characterising a geometry of a three-dimensional object. For example, this may comprise an STL file, a 3MF file or the like. In some examples, this model may be a mesh model, for example a polygon mesh such as a triangular mesh. In some examples, the mesh may be specified using a plurality of vertices having defined locations in 3D space. In other examples, the model may comprise an implicit model (for example being defined mathematically using models such as Non-uniform rational basis spline (NURBS)), a beam lattice model, a constructive solid geometry (CSG) model, or the like. The object may be described in the context of a space, and therefore may explicitly or implicitly describe a volume of space containing the object, including space that is external thereto.

The object model may be retrieved from a memory or received over a network or the like.

Block 104 comprises determining, using at least one processor (which may be the same or different to the processor(s) referred to in block 102) a transformed data model describing a volume containing a modified version of the three-dimensional object as a plurality of contiguous, non-overlapping sub-volumes, wherein the modified object described in the transformed data model includes a surface offset.

The non-overlapping sub-volumes may be different sizes. For example, as will be set out in greater detail herein, the transformed data model may divide a volume containing the object model into homogenous regions, wherein the regions are homogenous in that they are either internal or external to the object within the volume. Volumes which span an object boundary may be recursively divided (for example into four for a quadtree model, or into eight for an octree model) until they can be categorised as being internal or external, or until a sub-volume reaches a minimum size. In some examples, rather than being ‘internal’ or ‘external’, a region may be homogenous in relation to another property, for example a color or the like. However, as an offset is generally applied to object boundaries rather than property boundaries (e.g. a boundary between two colors), in the examples herein, internal and external sub-volumes are described. In some examples, object properties such as color may be associated with sub-volumes as metadata or the like.

For some examples, the transformed data model may comprise an octree model, for example an octree model in which the volume representing the largest volume (the ‘root’ node) is described first, followed by its octants, followed by their octants and so on. In other examples, the sub-volumes may be described in some other order.

In other words each sub-volume may be associated with an attribute describing whether the sub-volume comprises part of an object and each sub-volume may be categorised as one of:

(i) being wholly internal to the object (also termed ‘black’ herein),

(ii) being wholly external to the object (also termed ‘white’ herein),

(iii) spanning an object boundary (also termed ‘grey’ herein), such that a sub region of the sub-volume is internal to the object and another sub region is external.

There may be two categories of ‘grey’ sub-volumes—those which are greater than a threshold size, and the threshold ‘minimum’ size, which may be the smallest size of sub-volume, and which may be defined bearing in mind an intended object generation resolution (for example having a size such that different minimum sub-volumes may be associated with different additive manufacturing instructions).

The modified object described by the transformed data model includes a surface offset. Such a surface offset may for example be used to change a size and/or shape of an object.

This may be to modify the object for any purpose but in some examples, object model data may be modified to compensate for anticipated deviations in dimensions when generating an object.

For example, it may be the case that, where an object is generated in a process which includes heat, additional build material may adhere to the object on generation. In one example, fusing agent may be associated with a region of the layer which is intended to fuse. However, when energy is supplied, build material of neighbouring regions may become heated and fuse to the outside of the object (in some examples, being fully or partially melted, or adhering to melted build material as powder). Therefore, a dimension of an object may be larger than the regions to which fusing agent is applied. In order to compensate for this effect, i.e. where it is anticipated that an object may tend to ‘grow’ during manufacture, the object volume as described in object model data may be reduced.

In other examples, objects may be smaller following object generation than is specified in object model data. For example, some build materials used to generate objects may shrink on cooling. Therefore, an object volume in object model data may be increased to compensate for the anticipated reduction in volume.

A particular object may be subject to mechanisms which result in growth and/or shrinkage, and the appropriate transformation to apply may be influenced by the different degrees to which an object may be affected by such processes.

Such compensations may be applied using geometrical transformation which may include scaling and/or offsets. For example, a geometrical transformation may comprise at least one scaling factor and/or at least one offset value, and in some examples associate a scaling factor and/or offset value with at least one of three orthogonal (e.g. x, y and z) axes. A scaling factor may be used to multiply a set of specified object dimensions in the direction of at least one axis by a value, which may be greater than 1 in order to increase the dimension(s) and less than 1 to reduce the dimension(s), or equal to 1 to have no effect. The scaling factor may be applied to dimensions of an object model. Such a scaling factor may be relatively simple to apply to an object model (and indeed the object model referred to in block 102 may have already had a scaling factor applied thereto).

An offset may specify, for example by a specified distance or a number of defined voxels (i.e. 3D voxels, which may have the same size as the minimum sub-volume size in some examples), an amount to add or remove from a surface of the object (or a perimeter within a layer). For example, an offset distance as measured in the direction of a normal from the object surface may be specified and the object may be eroded or dilated (i.e., inflated or enlarged) by this distance, for example by moving the vertices of a mesh in the case of a mesh model, although other methods of providing an offset may be used in other examples. However, in some examples, object models such as mesh models may not be robust to such offsets, for example resulting in modified meshes having degenerate polygons (e.g. a triangle having a side length of zero). While other solutions may be more robust, these can be associated with high computing resource specifications and/or lengthy processing times.

The method of determining the transformed data model in FIG. 1 is now discussed in greater detail in relation to FIG. 2.

Block 202 comprises selecting a sub-volume for assessment.

In an example of recursive definition of the sub-volumes, the process may start with a cuboid enclosing a virtual object. This will be ‘grey’ as it includes space which is interior to the object as well as space which is external thereto. Therefore, the volume is split into sub-volumes. To consider the example of an octree, there will be eight such sub-volumes. Each one of these sub-volumes may then be assessed in turn. Alternatively, the method may apply after some iterations of subdivision, as explained in greater detail below.

Block 204 comprises defining a first region by determining an area swept by an offset operator when the offset operator is swept around the boundary of the sub-volume. The offset operator may have a size, and may operate on a region of space. For example, the offset operator may comprise a volume, for example a 3D volume. In other examples the offset operator it may comprise a two dimensional area operating within a slice, or a 1D operator having a size in one dimension. The offset operator may have the form of an isothetic prism (for example, a cuboid). The offset operator may have dimensions that span from (−δx, −δy, −δz) to (δx, δy, δz), where the offset to be applied is (δx, δy, δz). In other words, if the offset comprises an x-component, a y-component and a z-component, the offset operator is defined to have dimensions of twice the x-component by twice the y-component by twice the z-component. While negative offsets will be addressed in greater detail below, this example considers positive offsets—i.e. it is intended for an object to be increased in size in all axes.

The offset operator may be applied in the form of a Minkowski brush, with the centre of the offset operator following the boundary of the sub-volume during the sweep, and/or being applied such that the orientation of the operator does not change during the sweep.

Block 206 comprises defining a second region, interior to the first region, and indicative of the closest approach of the offset operator to the sub-volume during the sweep. Assuming that the operator volume is more than twice the volume of the selected sub-volume (which may be a condition of the method), the second region will fully enclose the sub-volume.

Block 208 comprises determining if a surface of the object model intersects with the second (smaller, or inner) region. To consider the example of some object models, this may be determined using ‘separating axis theorem’. This tests to see if there is a line onto which projections of two potentially intersecting objects may extend without overlapping. If the projections do not overlap, the objects (for example a polygon of a mesh model and a second region in this context) do not intersect. In other examples, testing for an intersection may comprise determining if the surface intersects by selecting an array of points within the first and second regions and determining if these points are points within the surface. For example, the points may be selected using a grid, or a Monte Carlo simulation, or the like. This provides an approximate solution. Such methods may be relatively computationally expensive, and may be applied for example to object models using mathematical models such as Non-uniform rational basis spline (NURBS), in which it may be difficult to determine intersections using less computationally expensive processes.

As is further set out below, the set o ‘candidate surface portions’ (e.g. polygons of a polygon mesh) may be selected from those which intersected with a parent sub-volume of the sub-volume under consideration, and such candidate surface portions may be considered without considering the rest of the portions of the surface.

If the object model surface intersects with the second region, the method proceeds to block 210, in which the sub-volume is categorised as wholly interior to the three-dimensional object. To express this another way using the terminology introduced above, the sub-volume is identified as being ‘black’. It may be noted that the smaller second region may (unless the offset is less than half the dimensions of the sub-volume) be larger (and enclose) the sub-volume. Therefore, this is a first mechanism by which the offset is integrated into the modified object modelled by the data.

If however the determination in block 208 is that the object model surface does not intersect with the second region, then the method proceeds to block 212, in which it is determined whether the object model surface intersects with the larger first region (and not the second region).

If so, the method proceeds to block 214 and the sub-volume is categorised as spanning a boundary of the three-dimensional object. To express this another way using the terminology introduced above, the sub-volume is identified as being ‘grey’. This provides a second mechanism for including the offset, as (unless the sub-volume is the smallest sub-volume of interest), this sub-volume may be further divided in a subsequent iteration of the method, and therefore some of the further ‘sub-sub-volumes’ may be categorised as being ‘black’, i.e. internal to the modified object modelled by the data, even though these are external to the original object model.

In some examples, if the determination in block 214 is negative (i.e. when the object model surface does not intersect with either the first or second region), the sub-volume may be categorised as being either interior or exterior to the three-dimensional object. To express this another way using the terminology introduced above, the sub-volume is identified as being ‘black’ or ‘white’. The determination may be made on the basis that any point location within the first region (which includes the second region) is internal or external to the object (as it is known that there is no surface intersection in this region, so what is true for that one point is true for the region as a whole. Therefore any point may be tested to determine if it is ‘black’ or ‘white’, for example using the coordinates of the point location relative to the coordinates of the object model.

It may be noted, that, in general, the method may be applied to sub-volumes formed from volumes which have been previously identified as ‘grey’ themselves. Therefore, this allows an increased resolution for inspection of this ‘grey’ volume, which may be divided into ‘white’, ‘grey’ and ‘black’ sub-volumes as appropriate. This in turn allows the volume of the modified object to include an offset.

In some examples, the method may be conditional on the offset being at least half the size of the sub-volume being evaluated. Larger sub-volumes may therefore be labelled as ‘grey’ without any inspection for intersections such that they are subdivided until they are of a small enough size that the offset is at least half the size (in some examples, in each dimension) of the sub-volume.

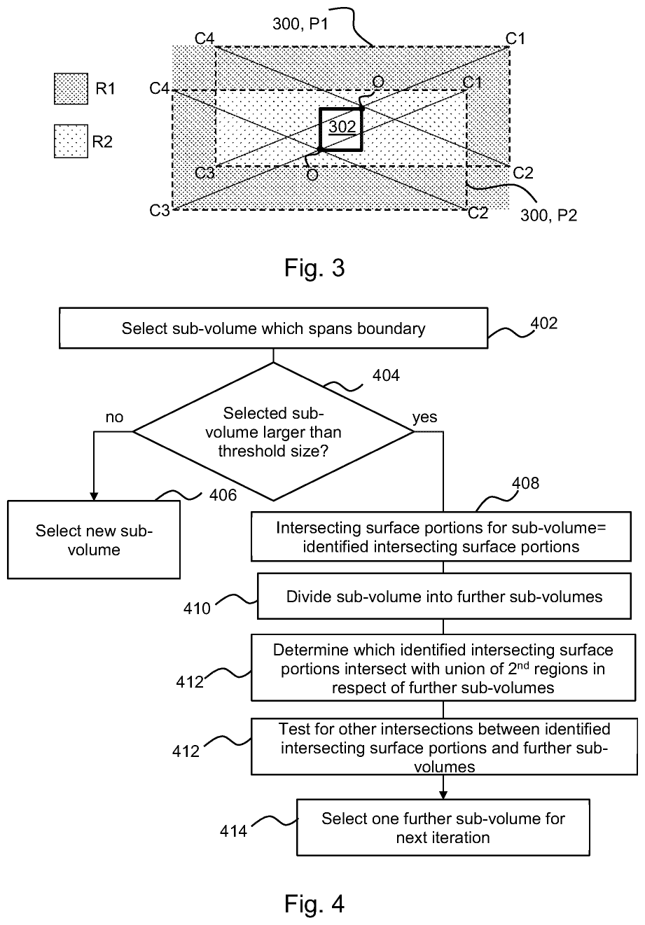

FIG. 3 illustrates the action of the offset operator 300 in two dimensions. FIG. 3 shows an offset operator 300 having dimensions of 2*δx by 2*δy, where δx and δy are the x and y offset values to be applied, a marked centre point, O and four corners labelled C1, C2, C3 and C4. The centre point O is aligned with the boundary of a sub-volume 302, and the operator 300 defines a volume as it is ‘swept’ around the boundary, without changing its orientation and while maintaining its centre point on the boundary. The operator 300 is shown in a first position P1 and a second position P2 during the sweep.

It may be noted that, as the operator 300 moves around the boundary, there is at least one corner which is maximally distant from the boundary, and that this corner changes during the sweep. This corner is C1 when the operator is in position P1 and C3 when the operator is in position P2. The maximally distant corners define the first region R1 described in relation to block 204. The diametrically opposite corner to the maximally distant corner defines the closest approach of the operator 300 to the boundary, and therefore defines the second region R2 described in relation to block 204. This corner is C3 when the operator 300 is in position P1 and C1 when the operator is in position P2.

It may therefore be seen that the operator 300 “inflates” each sub-volume 302 before intersections with the object surface are determined, defining in effect an offset window comprising the first and second regions R1 and R2, wherein the offset extends the object into a volume within this window. While the Figure shows an example in 2D, the method may be applied in other dimensions.

FIG. 4 shows how the method of FIG. 2 may iterate through a plurality of stages, each relating to progressively smaller sub-volumes in some examples. For example, the method may iterate through around between 10 and 20 levels of sub-volumes.

Block 402 comprises selecting a sub-volume which is categorised as spanning a boundary (i.e. a ‘grey’ sub-volume). Block 404 comprises determining if the sub-volume is above a threshold minimum size, which may be selected based on the intended manufacturing resolution. If not, the method terminates with respect to that sub-volume, and moves onto another sub-volume (block 406). If however the sub-volume is above the minimum size, then the sub-volume is to be further divided and method continues with block 408, which comprises identifying any defined object model surface portions (for example, polygons or other surface facets) which intersected with the selected sub-volume. For example, this may comprise one or a plurality of triangles of a triangular polygon mesh. These surface portions are referred to as ‘identified intersecting surface portions’ for the sake of the next iteration of sub-division. This ‘prunes’ the list of possible surface portions in the object model to assess in relation to the next stage to the identified intersecting surface portions, which provide candidate surface portions to compare with the ‘children’ of this sub-volume, which may contribute to increasing processing efficiency.

The method then proceeds to block 410, which comprises dividing that sub-volume into further sub-volumes. For example, in the case of an octree, the sub-volume may be divided into octants.

Block 412 comprises determining which of the identified intersecting surface portions identified in block 408 intersect with a region of a union of the second regions of all of the further sub-volumes. This may be determined with a single test in some examples (e.g. a single test using separating axis theorem, wherein one of the objects is the union of the second regions, and the other object is the surface portion under test). Any surface portion which intersects the union of the second regions intersects with all the first regions defined with respect to the further sub-volumes. This single test may therefore allow a plurality of intersections to be determined for all the child sub-volumes.

In other words, this effectively performs the test for intersection between a particular candidate surface portion and that section of the first region (block 212 of FIG. 2) simultaneously for all child sub-volumes, instead of testing that candidate surface portion against each of the first regions of the child sub-volumes individually.

While this stage need not be carried out in all examples, this may improve processing speeds and/or reduce processing resources as a single test may be used rather than multiple tests. Such principles may be extended to any section of the first and second portions which intersect between at least two sub-volumes, and therefore to other groupings of sub-volumes (for example, the top four sub-volumes and the bottom four sub-volumes in an octree), further reducing processing resources consumed.

Other intersections may be identified in block 414. For example, this may comprise testing identified intersecting surface portions which do not intersect the union of the second regions against the first and second regions of each further sub-volumes, and/or testing the identified intersecting surface portions for intersections with the first regions of the further, or child sub-volumes.

Block 414 comprise selecting one of the further, or child, sub-volumes. The method of FIG. 2 and in some examples FIG. 4 may be applied to the new selected sub-volume.

In some examples, block 414 may be carried out after blocks 204 and 206 have been performed for all further, or child, sub-volumes. In other examples, the method may propagate through a volume containing a virtual object one generation at a time, starting with the largest sub-volume remaining until all sub-volumes are categorised as black or white or are at their minimum size.

It may be noted that testing surface portions such as polygons of a mesh model or other surface portions for other object model types for intersections with volumes is relatively resource intensive. Therefore, ‘pruning’ the list of surface portions as set out in relation to block 408 and/or block 412 for testing can have a considerable effect on processing speeds. This may be particularly the case in the context of this disclosure as, instead of considering the intersections with each sub-volume, a larger region is considered, which will tend to increase the number of intersections associated with a sub-volume (meaning that ‘pruning’ on the basis of the intersections with a parent sub-volume—i.e. those identified in block 204—may be slower than in other cases).

It may also be noted that any surface portion which intersects with a region which is the intersection of the second regions need not be tested in respect of each further sub-volume. Once this has been established for one further sub-region, it may be assumed for all others. Therefore a point inside the union may be selected as a test location, as any polygon which intersects this point will intersect all second regions. This may for example be the point at which the sub-volumes meet.

Moreover, as was noted above, in some examples, if the determination in block 214 is negative (i.e. when the object model surface does not intersect with either the first or second region), the sub-volume may be categorised as being either interior or exterior to the three-dimensional object by testing a single point. Selecting the single point as being the intersection may therefore allow a plurality of further sub-volumes under consideration to be categorised at once.

While ‘black’ and ‘white’ sub-volumes may also be divided to provide sub-volumes of the minimum size (e.g. considering object generation resolution), this is trivial in terms of their categorisation as all children of a black sub-volume will be black and all children of a white sub-volume will be white.

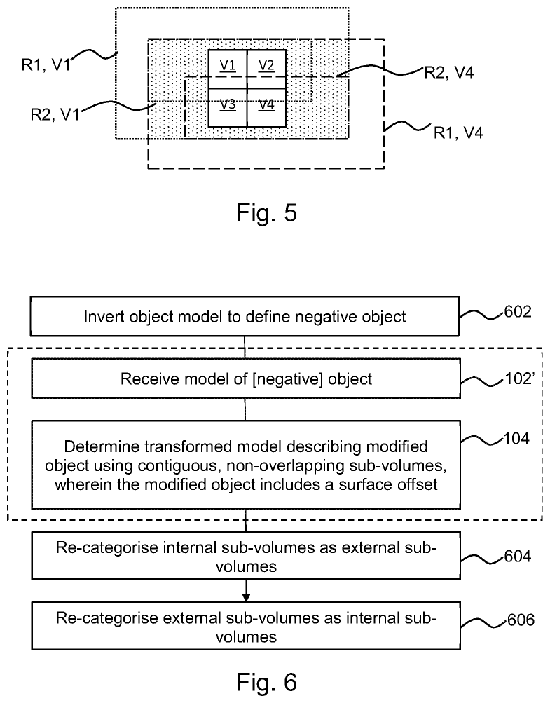

FIG. 5 illustrates the principle of block 412. Four further sub-volumes, V1, V2, V3, V4 have been defined. The first and second regions of V1 and V4 are marked, while the regions of V2 and V3 are not marked to avoid over complicating the figure. The shaded region falls within at least the perimeter of the first region of each of the sub-volumes, and may be defined as the union of all the second regions for V1, V2, V3, V4. This shaded region may provide an ‘object’ which may be tested for intersections with the surface in a single test, for example a ‘separating axis’ test as described above, and tests at least a section of the first regions at once.

FIG. 6 describes a method which may be applied in the case of a negative offset—i.e. the object is to be made smaller in all axes. In order to process such an offset, the object model is inverted such that the offset may be treated as a positive offset, and the methods described above may then be directly applicable thereto.

Block 602 comprises inverting the object model to define a negative of the object. In particular, the object model may be inverted such that external surfaces are redefined as internal surfaces. For example, the orientation of a polygon mesh may be reversed by changing the direction of the normal vector of every polygon thereof.

The method then proceeds as set out in FIG. 1, although in this case the received object model represents a negative object (block 102′). As set out above, this method may proceed using an operator (for example having dimensions which are double the magnitude of the negative offsets) to categorise the sub-volumes of the virtual object as described in relation to FIG. 2. Although in this case the object is a negative object, there is no need to adapt the method of FIG. 2, which may be carried out as set out above. The method may repeat iteratively until all sub-volumes are categorised as internal or external (to the negative object), or are at the minimum defined size. As the offset is being treated as a positive offset, this will mean that the operation decreases the size of the negative object, or increases the size of the region surrounding the original object model.

Once the process has been completed, the method further comprises re-categorising the sub-volume(s) that were initially categorised as wholly interior as being wholly external to the object (block 604) and re-categorising the sub-volume(s) initially categorised as wholly external as being interior to the object (block 606). In other words, the categorisation of each of the sub-volumes is reversed, to restore a ‘positive’ virtual object, defined in terms of its sub-volumes, and including a negative offset. In some examples, blocks 604 and 606 may be carried out in an overlapping time frame, for example by ‘traversing’ the sub-volumes.

The methods set out herein may produce correct results for offsets larger or equal than half the size a sub-volume in each direction. However, in some examples, the method may, in the case of a positive offset, categorise a sub-volume as “grey” when it is actually “black” (or “grey” when it is actually “white” for the negative offsets). With positive offsets, this may occur near sharp concave angles, where object faces are spaced by values close to the offset, and the first region of one sub-volume may interact with that of another. However, this is unlikely to result in significant issues, and/or such acute angles could be identified and handled as an exception in some examples.

For negative offsets, it is needle-like or sharp edges which may be impacted (as, in the negative or inverted virtual object, these will have surfaces which face one another). This could result in small protrusions appearing near some such features. This may be acceptable in some circumstances or could be addressed in a separate processing operation, for example being tagged for user input.

It may be noted that, when extended by the method of FIG. 6, the methods set out herein may therefore be used when an object is to be made larger in all axes and when the object is to be made smaller in all axes, and not with a mixture of negative and positive offsets.

The methods set out herein may further comprise determining control instructions for generating an object and, in some examples, generating an object. Examples of determining control instructions and generating an object are set out in greater detail below. Grey voxels of the minimum size may be associated with instructions to be solidified, or not, or may be associated with modified print instructions as appropriate.

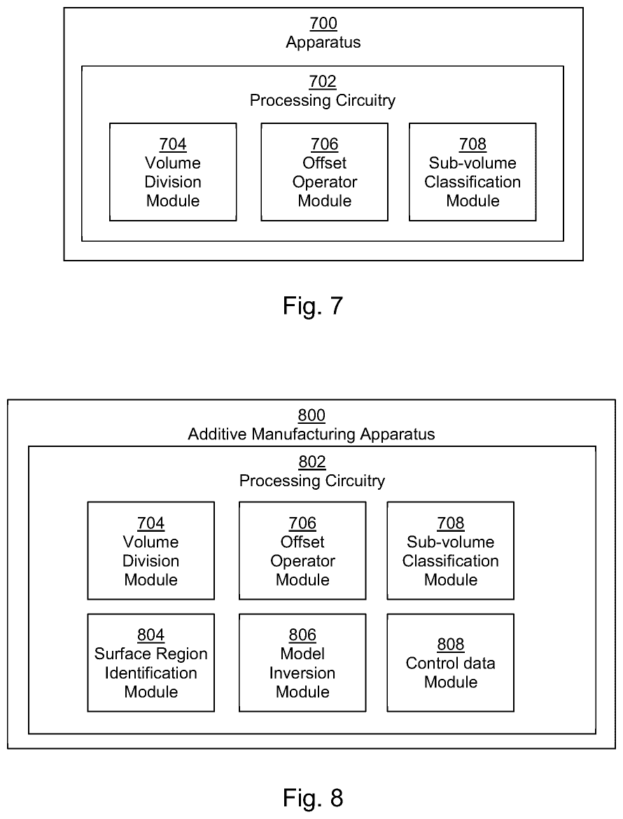

FIG. 7 shows an example of an apparatus 700 comprising processing circuitry 702, the processing circuitry 702 comprising a volume division module 704, an offset operator module 706 and a sub-volume classification module 708.

In use of the apparatus 700, the volume division module 704 divides a model of an object into sub-volumes. In particular, the volume division module 704 recursively (or iteratively, or repeatedly) subdivides sub-volumes which span an object boundary. The sub-volumes may have any of the characteristics of the sub-volumes described above. The subdivision may continue until a threshold sub-volume size is reached, for example an intended size of object generation resolution. In some examples, the volume division module 704 may also recursively subdivide other volumes, for example internal and external volumes, for example until the threshold sub-volume size is reached.

In use of the apparatus 700, the offset operator module 706 inflates at least one sub-volume to define an offset window, the offset window comprising a first region comprising the area swept by an offset operator when the offset operator is swept around the boundary of the sub-volume and a second region, interior to the first region, and indicative of the closest approach of the offset operator to the sub-volume during the sweep.

In use of the apparatus 700, the sub-volume classification module 708 classifies sub-volumes as being internal to the object (including the offset), external to an object or spanning an object boundary. In some examples, when the object model surface intersects the second region, the sub-volume classification module 708 classifies the sub-volume as being interior to the three-dimensional object; and when the object model surface intersects with the first region and not the second region the sub-volume classification module 708 classifies the sub-volume as spanning a boundary of the three-dimensional object. In some examples, when the object model surface does not intersect with either the first or second region, the sub-volume classification module 708 classifies the sub-volume as being interior or exterior to the three-dimensional object based on a test of any point within the sub-volume, and in some examples based on a test of a point of intersection with other sub-volumes such that the result of the test may be shared between sub-volumes, as described in greater detail above.

For example, the sub-volume classification module 708 may utilise the principles described above relating to methods to categorise the sub-volumes.

FIG. 8 shows an example of an additive manufacturing apparatus 800 comprising processing circuitry 802, wherein the processing circuitry 802 comprises the volume division module 704, offset operator module 706 and sub-volume classification module 708 described in relation to FIG. 7. In addition, the additive manufacturing apparatus 800 further comprises a surface portion identification module 804, a model inversion module 806 and a control data module 808.

In use of the additive manufacturing apparatus 800, the surface portion identification module 804 identifies surface portions (e.g. polygons) which intersect with at least one of the first and second region of a given sub-volume and tests those identified surface portion(s) to determine if they intersect with child sub-volumes of that sub-volume in a next iteration of the recursive sub-division operation. This may assist in ‘pruning’ the list of surface portion to be tested against sub-volumes in subsequent iterations, as described above. The surface portion identification module 804 may for example carry out any of the processes described in relation to FIG. 4.

In use of the additive manufacturing apparatus 800, the model inversion module 806 inverts an object model when an offset to be applied thereto is a negative offset. For example, this may allow the offset to be treated as a positive offset as described above. The sub-volume classification module 708 may for example invert the classification of the sub-volumes (i.e. switch white to black, and vice versa) once the subdivision of the negative object is complete.

The control data module 808 determines, in use of the additive manufacturing apparatus 800, additive manufacturing apparatus control data to generate an object from the classified sub-volumes, which describe the object to be generated including an offset. The control data (which may also be referred to as object generation instructions or print instructions) in some examples may specify an amount of print agent to be applied to each of a plurality of locations on a layer of build material. An amount of print agent (or no print agent) may be associated with each of the sub-volumes defined by the volume division module 704, for example based on their category as defined by the sub-volume classification module 708 (in some examples, along with other considerations, such as an expectation of heat transfer from nearby regions, property specifications such as color and the like, etc.). For example, if a sub-volume relates to a region of a build volume which is intended to solidify, the control data may be determined to specify that fusing agent should be applied to a corresponding region of build material in object generation. If however a sub-volume relates to a region of the build volume which is intended to remain unsolidified, then control data may be determined to specify that no agent, or a coalescence modifying agent such as a detailing agent, may be applied thereto, for example to cool the build material. In addition, the amounts of such agents may be specified in the generated control data and these amounts may be determined based on, for example, thermal considerations and the like. In other examples, control data may specify how to direct directed energy, or how to place a binding agent or the like.

In use of the additive manufacturing apparatus 800, at least one object may be generated using the control data.

The control data may in some examples specify an amount of print agent to be applied to each of a plurality of locations on a layer of build material.

The additive manufacturing apparatus 800, in use thereof, may generate the object in a plurality of layers (which may correspond to respective slices of an object model) according to control data. The additive manufacturing apparatus 800 may for example generate an object in a layer-wise manner by selectively solidifying portions of layers of build material. The selective solidification may in some examples be achieved by selectively applying print agents, for example through use of ‘inkjet’ liquid distribution technologies, and applying energy, for example heat, to the layer. In other examples, heat may be selectively applied, and/or chemical agents such as curing or binding agents may be applied. The additive manufacturing apparatus 800 may comprise additional components not shown herein, for example any or any combination of a fabrication chamber, a print bed, printhead(s) for distributing print agents, a build material distribution system for providing layers of build material, energy sources such as heat lamps and the like.

The processing circuitry 702, 802 or the modules thereof may carry out any of the blocks of FIG. 1, 2, 4 or 6.

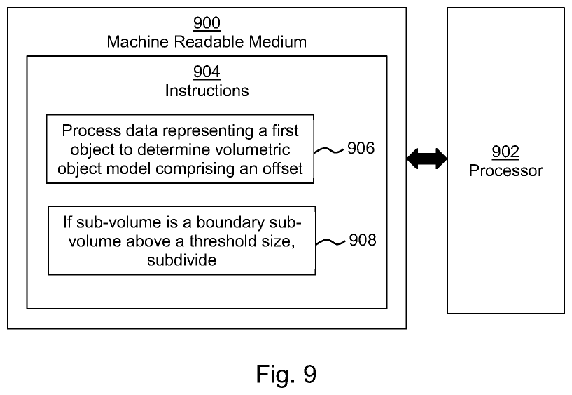

FIG. 9 shows a tangible machine-readable medium 900 associated with a processor 902. The machine-readable medium 900 comprises instructions 904 which, when executed by the processor 902, cause the processor 902 to carry out tasks. In this example, the instructions 904 comprise instructions 906 to cause the processor 902 to process data representing a first object as a virtual object to determine a volumetric model of the virtual object comprising an offset. The volumetric model of the virtual object is described using a plurality of sub-volumes, e.g. contiguous, non-overlapping sub-volumes as described above. The offset is added to the volumetric model using a Minkowski operator having dimensions based on the offset to define a first region surrounding a first sub-volume and defining the first sub-volume as one of an interior sub-volume and a boundary sub-volume if the virtual object surface intersects with the region defined by the Minkowski operator.

The instructions further comprise instructions 908 to, if the sub-volume is a boundary sub-volume of above a threshold size, subdivide the sub-volume and to apply the Minkowski operator to the subdivided sub-volume. This method may be carried out iteratively.

In some examples, the machine-readable medium 900 comprises instructions which, when executed by the processor 902, cause the processor 902 to define an inner region indicative of the closest approach of the Minkowski operator to the sub-volume, wherein if the mesh intersects with the first region and not the inner region, the sub-volume is categorised as being a boundary sub-volume. In other words, the Minkowski operator may operate as described above in relation to the offset operator.

In some examples, the instructions when executed cause the processor 902 to carry out any of the blocks of FIG. 1, 2, 4 or 6, and/or to act as any of the modules of the processing circuitry 702, 802 of FIG. 7 or FIG. 8, with the offset operator being provided by the Minkowski operator.

Examples in the present disclosure can be provided as methods, systems or machine readable instructions, such as any combination of software, hardware, firmware or the like. Such machine readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted, and at least some processes may be carried out in parallel. Blocks described in relation to one flow chart may be combined with those of another flow chart. It shall be understood that at least some blocks in the flow chart, as well as combinations of the blocks in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices (for example, any of the volume division module 704, offset operator module 706, sub-volume classification module 708, surface portion identification module 804, model inversion module 806 and the control data module 808) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
receiving, at a processor, an object model describing a geometry of a three-dimensional object;
determining, using at least one processor, a transformed data model describing a volume containing a modified version of the three-dimensional object as a plurality of categorised contiguous, non-overlapping sub-volumes, wherein the modified version of the three-dimensional object includes a surface offset;
wherein determining the transformed data model comprises categorising the sub-volumes by:
defining a first region by determining an area swept by an offset operator when the offset operator is swept around a boundary of the sub-volume;
defining a second region, interior to the first region, and indicative of the closest approach of the offset operator to the sub-volume when the offset operator is swept around the boundary; and
determining whether a surface of the object model intersects at least one of the first and second region,
wherein:
when the surface intersects the second region, the sub-volume is categorised as interior to the three-dimensional object; and
when the surface intersects the first region and not the second region, the sub-volume is categorised as spanning a boundary of the three-dimensional object.

2. A method according to claim 1 wherein the surface offset to be included in the modified version of the three-dimensional object comprises an x-component, a y-component and a z-component, and the offset operator is defined to have dimensions of twice the x-component by twice the y-component by twice the z-component.

3. A method according to claim 1 wherein a centre of the offset operator follows the boundary of the sub-volume during the sweep.

4. A method according to claim 1 further comprising, if a sub-volume is categorised as spanning a boundary of the three-dimensional object:
dividing that sub-volume into further sub-volumes; and
categorising each further sub-volume using the offset operator.

5. A method according to claim 4 wherein dividing the sub-volume is conditional on the sub-volume being above a threshold size.

6. A method according to claim 4 wherein determining if the surface intersects with a sub-volume comprises determining if each of a plurality of object model surface portions intersects with at least one of the first and second regions;
the method comprising identifying the object model surface portions which intersect with at least one of the first and second regions of a sub-volume; and
categorising the further sub-volumes comprises determining if each of the identified object model surface portions intersects with at least one of the first and second regions defined with respect to all the further sub-volumes.

7. A method according to claim 6, further comprising:
identifying the object model surface portions which interact with a region corresponding to a region of a union of the second regions of all of the further sub-volumes into which the sub-volume is to be divided, and on that basis determining that that the identified object model surface portions intersects with the first regions defined with respect to all the further sub-volumes.

8. A method according to claim 1 further comprising, when the surface offset is a negative offset:
inverting the object model characterising a geometry of a three-dimensional object to form a negative of the object;
forming sub-volumes of a volume containing the negative of the object;
categorising the sub-volumes using the offset operator; wherein
determining the transformed data model further comprises:
re-categorising the sub-volumes categorised as being interior to the object as external to the object; and
re-categorising the sub-volumes categorised as being external to the object as interior to the object.

9. Apparatus comprising processing circuitry, the processing circuitry comprising:
a volume division module to divide a model of an object into sub-volumes, wherein the volume division module is to recursively subdivide sub-volumes which span an object boundary;
an offset operator module to inflate at least one sub-volume to define an offset window, the offset window comprising a first region comprising an area swept by an offset operator when the offset operator is swept around a boundary of the sub-volume and a second region, interior to the first region, and indicative of the closest approach of the offset operator to the sub-volume during the sweep;
a sub-volume classification module to classify sub-volumes as being internal to the object, external to an object or spanning an object boundary, wherein:
when a surface of the model of the object intersects the second region, the sub-volume classification module is to classify the sub-volume as being interior to the object; and
when the surface intersects with the first region and not the second region the sub-volume classification module is to classify the sub-volume as spanning a boundary of the object.

10. Apparatus according to claim 9 wherein the processing circuitry further comprises:
a surface portion identification module to identify surface portions which intersect with at least one of the first and second region and to test those identified surface portions to determine if they intersect with a child sub-volume of that sub-volume in a next iteration of the recursive subdivision.

11. Apparatus according to claim 9 wherein the processing circuitry further comprises:
a model inversion module to invert the model of the object when an offset to be applied thereto is a negative offset prior to volume division by the volume division module, and wherein the sub-volume classification module is to invert the classification of the sub-volumes once the subdivision is complete.

12. Apparatus according to claim 9 further comprising a control data module to determine additive manufacturing apparatus control data to generate an object from the classified sub-volumes.

13. Apparatus according to claim 12 further comprising additive manufacturing apparatus to generate at least one object using the additive manufacturing apparatus control data.

14. Tangible machine-readable medium storing instructions which, when executed by a processor, cause the processor to:
process data representing a first object as a virtual object to determine a volumetric model of the virtual object comprising an offset, wherein:
the volumetric model of the virtual object comprising an offset is described using a plurality of sub-volumes, and
the offset is added using a Minkowski operator having dimensions based on the offset to define a first region surrounding a first sub-volume of the volumetric model and classifying the first sub-volume as one of an interior sub-volume and a boundary sub-volume if a surface of the virtual object surface intersects with the region defined by the Minkowski operator; and
if the sub-volume is a boundary sub-volume of above a threshold size, to subdivide the sub-volume and to apply the Minkowski operator to the subdivided sub-volume.

15. Tangible machine-readable medium according to claim 14 further storing instructions to define an inner region indicative of the closest approach of the Minkowski operator to the sub-volume, wherein if the surface of the virtual object intersects with the inner region and not the first region, the sub-volume is categorised as being a boundary sub-volume.
